(19) United States
(12) Patent Application Publication
(10) Pub. No.: US 2019/0220150 A1
(43) Pub. Date: Jul. 18, 2019

(54) TOUCH SENSOR AND METHOD FOR MANUFACTURING THE SAME

(71) Applicant: SHENZHEN ROYOLE TECHNOLOGIES CO. LTD., Shenzhen, Guangdong (CN)

(72) Inventor: Yao HU, Shenzhen, Guangdong (CN)

(21) Appl. No.: 16/334,300

(22) PCT Filed: Sep. 26, 2016
(86) PCT No.: PCT/CN2016/100112

§ 371 Date: Mar. 18, 2019

(51) Int. Cl. G06F 3/044; H01B 3/18

(52) U.S. Cl. CPC G06F 3/0445; G06F 2203/04103; H01B 3/18

(57) ABSTRACT

A touch sensor includes a substrate, a conductive layer laminated on a surface of the substrate. The conductive layer includes a conductive region and an insulating region. The conductive region and the insulating region are formed by locally treating an original material layer having conductive particles. The treated region of the original material layer forms the conductive region where the conductive particles are substantially electrically connected to each other. The untreated region of the original material layer forms the insulating region where the conductive particles are substantially separated from each other.

### RELATED APPLICATION

The present application is a National Phase of International Application Number PCT/CN2016/100112, filed Sep. 26, 2016.

### TECHNICAL FIELD

The present disclosure relates to a field of the electronic touch technology, and more particularly relates to a touch sensor and a method for manufacturing the touch sensor.

### BACKGROUND

With the rapid development of the electronics industry, touch technology has gradually entered people's lives. The early glass touch panels are patterned by etching metal conductive layers or ITO conductive layers thereof. When the finger touches the patterned panel, the capacitance of the contact point is changed to input signals into chips. Gaps exist between the patterned conductive lines. The gaps are generally filled with protective layers, optical layers, or adhesive layers formed on the conductive lines. When the gap is greater than 20 um, and the difference between reflection coefficient of the materials of the conductive lines and the material filling the gap is large, the gap may be perceived by the human eye.

### SUMMARY

Embodiments of the present disclosure provide a touch sensor and a method for manufacturing the touch sensor, which avoids perceiving gaps between the conductive patterns.

A touch sensor provided by the present disclosure includes a substrate, a conductive layer laminated on a surface of the substrate. The conductive layer includes a conductive region and an insulating region. The conductive region and the insulating region are formed by locally treating an original material layer having conductive particles. The treated region of the original material layer forms the conductive region. The untreated region of the original material layer forms the insulating region. The conductive region includes the conductive particles substantially electronically connected to each other, and the insulating region includes the conductive particles substantially separated from each other

Therein, the original material layer, the insulating region, and the conductive region each include insulating particles, the insulating particles in the insulating region are substantially located among the conductive particles, and the insulating particles in the conductive region are substantially located at sides of the conductive particles.

Therein, the insulating region includes a number of layers of insulating particles and a number of layers of conductive particles, and two adjacent layers of conductive particles in the insulating region are separated by a layer of insulating particles.

Therein, the conductive region includes a number of layers of conductive particles, two adjacent layers of conductive particles in the conductive region contact each other, and the insulating particles in the conductive region are adjacent to the substrate

Therein, the particle sizes of the insulating particles in the conductive region are substantially smaller than the particle sizes of the insulating particles in the insulating region.

Therein, the insulating particles of the original material layer are decomposed to form the insulating particles of the conductive region.

Therein, the original material layer includes an insulating photosensitive layer, an irradiated region of the insulating photosensitive layer forms the conductive region and an unirradiated region of the insulating photosensitive layer forms the insulating region in the locally treating process.

Therein, the insulating particles of the original material layer include composite organogel particle of calixarene and derivative of trifluoromethanesulfonic acid or triphenylsulfonate protected by a T-phenylalanine molecular group.

Therein, the mass ratio of the calixarene to derivative of trifluoromethanesulfonic acid or triphenylsulfonate is 1:9.5˜1:10.

Therein, the T-type phenylalanine molecular group of the insulating particles in the original material layer falls off in the locally treating process.

Therein, the touch sensor further includes a cover plate covering the conductive layer. The cover plate is connected to the conductive region and the insulating region of the conductive layer by an adhesive layer.

Therein, the difference in reflectance between the insulating region and the conductive region is less than 1%.

A method for manufacturing a touch sensor includes forming an original material layer on a substrate, the original material including insulating particles and conductive particles distributed in the insulating particles; and locally treating the original material layer, the treated region of the original material layer forming a conductive region where the conductive particles therein are substantially electrically connected to each other, and the untreated region of the original material layer forming an insulating region where the conductive particles therein are substantially separated by the insulating particles.

Therein, the insulating particles in the conductive region are substantially located at sides of the conductive particles, and the insulating particles in the insulating region are substantially located among the conductive particles.

Therein, the insulating particles and the conductive particles in the insulating region are alternately stacked layer by layer, and the insulating particles in the conductive region are gathered adjacent to a surface of the substrate.

Therein, the particle sizes of the insulating particles in the conductive region are substantially smaller than the particle sizes of the insulating particles in the insulating region.

Therein, the original material layer is a photosensitive material layer.

Therein, locally treating the original material layer includes locally irradiating the original material layer and neutralizing the irradiated original material layer.

Therein, the insulating particles in the original material layer include acidic particles protected by molecular groups, and the molecular groups fall off to expose the acidic particles when locally irradiating the original material layer.

Therein, the acidic particles are neutralized with a weak alkaline solution to form the insulating particles of the conductive region after locally irradiating the original material layer.

The conductive layer of the touch sensor in the present disclosure is formed by doping the insulating photosensitive particles and the conductive particles into the original material layer then to be patterned. The conductive particles in the irradiated region are electrically connected to form the conductive region and the unirradiated region remains insulated to form the insulating region. The unirradiated region is not removed and remains in place. Furthermore, even the unirradiated region may be soaked in the alkaline solution and irradiated, the optical properties thereof are insignificantly changed. Thus, the unirradiated region may not be perceived by the human eye.

### BRIEF DESCRIPTION OF THE DRAWINGS

To more clearly illustrate the technical solutions in the embodiments of the present disclosure, the companying drawings to be used in the embodiments will be briefly described below. Obviously, the drawings in the following description are only some embodiments of the present disclosure. Those skilled in the art can also obtain other companying drawings based on these drawings without paying any creative effort.

FIG. 1 is a schematic structural view of a touch sensor according to an embodiment of the present disclosure.

FIG. 2 is a schematic view of a portion of an internal structure of an insulating region of the touch sensor illustrated FIG. 1.

FIG. 3 is a schematic view of a portion of an internal structure of a conductive region of the touch sensor illustrated in FIG. 1.

FIG. 4 is a flow chart of a method for manufacturing a touch sensor according to an embodiment of the present disclosure.

FIG. 5 to FIG. 7 are schematic views of processes of the method for manufacturing the touch sensor illustrated in FIG. 4.

### DETAILED DESCRIPTION OF ILLUSTRATED EMBODIMENTS

Technical solutions of the embodiments of present disclosure will be clearly and completely described in details below with reference to the accompanying drawings.

The present disclosure provides a touch sensor and a touch device using the touch sensor. Touch devices may be mobile phones, tablets, touch screens, and the like. The touch sensor includes a substrate, a conductive layer laminated on a surface of the substrate. The conductive layer includes a conductive region and an insulating region. The conductive region and the insulating region are formed by locally treating an original material layer having conductive particles. The treated region forms the conductive region where the conductive particles are substantially electrically connected to each other, and the untreated region forms the insulating region where the conductive particles are substantially separated from each other. The original material layer further includes insulating particles. The insulating particles in the insulating region are located among the conductive particles. The insulating particles in the conductive region are substantially located at sides of the conductive particles. Furthermore, the original material layer includes an insulating photosensitive layer. An irradiated region of the insulating photosensitive layer forms the conductive region, and an unirradiated region of the insulating photosensitive layer forms the insulating region in the locally treating process.

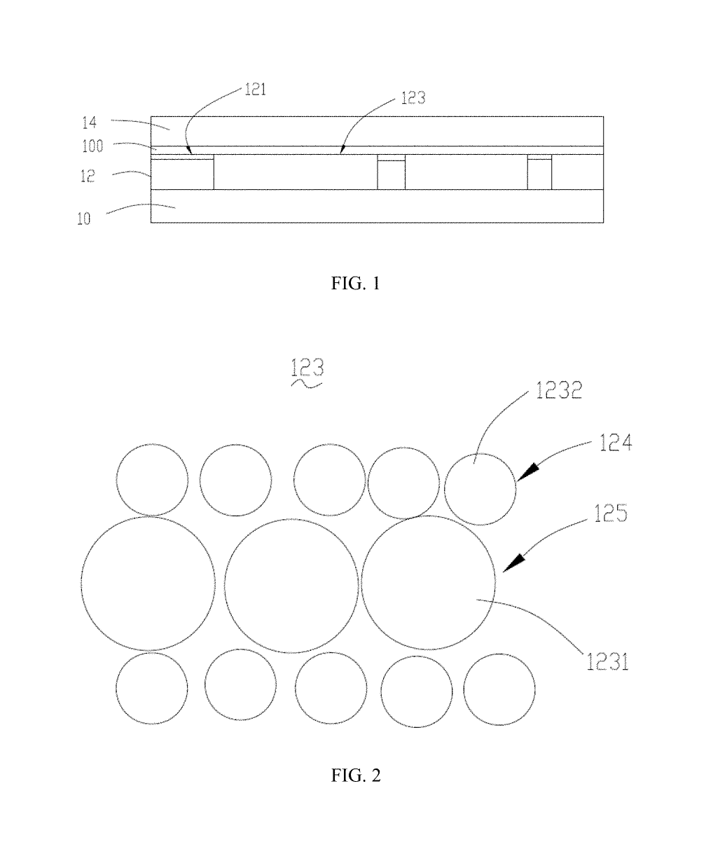

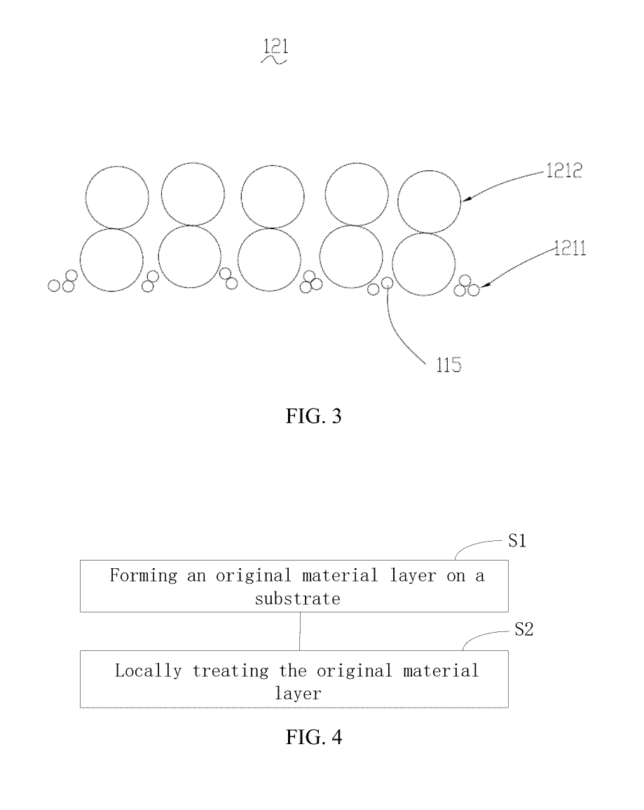

The present disclosure is described in the following specific embodiments. Referring to FIG. 1, the touch sensor includes a substrate 10, a conductive layer 12 laminated on a surface of the substrate 10, and a cover plate 14 laminated on the conductive layer 12. In this embodiment, the conductive layer 12 and the cover plate 14 are connected by an adhesive layer 100. Referring to FIG. 2 and FIG. 3, the conductive layer 12 includes a number of conductive regions 121 and a number of insulating regions 123 separating the conductive regions 121.

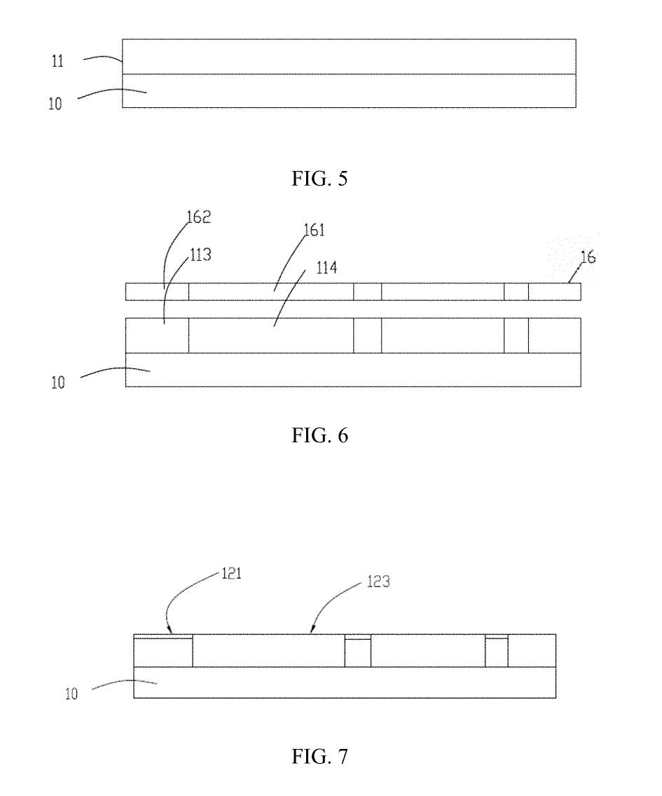

The conductive region 121 includes a number of layers of conductive particles. Two adjacent layers of conductive particles in the conductive region 121 contact each other. The insulating particles of the conductive region 121 are adjacent to the substrate 10. The particle size of the insulating particles in the conductive region 121 is substantially smaller than the particle size of the insulating particles in the insulating region 123. The insulating particles of the conductive region 121 are formed by decomposing the insulating particles of an original material layer 11, illustrated in FIG. 5. Specifically, the conductive layer 12 of the conductive region 121 includes an insulating particle layer 1211 and a first conductive particle layer 1212 laminated on the insulating particle layer 1211. It is to be noted that the first conductive particle layer 1212 laminated on the insulating particle layer 1211 in this embodiment also includes the conductive particles in the first conductive particle layer 1212 partially embedded in the insulating particle layer 1211. The insulating particle layer 1211 includes a number of insulating particles. In particular, the insulating particle layer 1211 includes a number of small insulating acidic molecule particles 115. The insulating particle layer 1211 in the conductive region 121 is located below the first conductive particle layer 1212, that is, adjacent to the substrate 10. The first conductive particle layer 1212 includes a number of layers of conductive particles located above the insulating particle layer 1211 and substantially electrically connected to each other, thereby to realize the conduction of the conductive region 121.

As illustrated in FIG. 2, the insulating region 123 includes a number of layers of insulating particles 1231 and a number of layers of conductive particles 1232. Two adjacent layers of conductive particles 1232 in the insulating region 123 are separated by a layer of insulating particles 1231. Specifically, the conductive layer 12 of the insulating region 123 includes insulating photosensitive particles 1231 and conductive particles 1232 separated by the insulating photosensitive particles 1231. The conductive particles 1232 in the insulating region 123 are insulated from each other in a direction perpendicular to the substrate 10. The material of the conductive particles 1232 in the insulating region 123 is the same as the material of the conductive particles in the first conductive particle layer 1212.

Exemplarily, the conductive particles 1232 form a number of second conductive particle layers 124, and the insulating photosensitive particles 1231 form a number of insulating photosensitive layers 125. Every two adjacent second conductive particle layers 124 are separated by the insulating photosensitive layer 125 formed by the insulating photosensitive particles 1231. In this embodiment, the insulating photosensitive layer 125 is located between two adjacent second conductive particle layers 124 such that two adjacent second conductive particle layers 124 are prevented from contacting each other. The difference in reflectance between the insulating region 123 and the conductive region 121 is less than 1%.

In this embodiment, the composition of the insulating particles 1231 of the insulating photosensitive layer 125, that is, the composition of the insulating particles of the original material layer 11, is composite organogel particles of calixarene and derivative of trifluoromethanesulfonic acid or triphenylsulfonate protected by T-phenylalanine molecular group. Due to the protection of the T-Boc molecular group, that is, T-phenylalanine molecular group, the chemical properties of the composite organogel particles of the calixarene and the derivative of trifluoromethanesulfonic acid or triphenylsulfonate are inactive.

In this embodiment, the mass ratio of the calixarene to the derivative of trifluoromethanesulfonic acid or triphenylsulfonate is 1:9.5 to 1:10. It is to be noted that the original composition of the insulating particles forming the insulating particle layer 1211 is the same as that of the insulating photosensitive particles 1231 of the insulating photosensitive layer 125.

In this embodiment, the particle size of the insulating photosensitive particle 1231 in the insulating photosensitive layer 125 ranges from 80 nm to 150 nm. The particle size of the conductive particle in the first conductive particle layer 1212 and the particle size of the second conductive particle layer 124 each range from 30 nm to 70 nm. The conductive particles in the first conductive particle layer 1212 and the conductive particles in the second conductive particle layer 124 are Ag. Since the insulating photosensitive particles 1231 in the insulating photosensitive layer 125 have a large particle size, the second conductive particle layers 124 are separated, thereby keeping the entire insulating photosensitive layer 125 insulated.

Referring to FIG. 4, a method for manufacturing a touch sensor according to the present disclosure includes operations in the following blocks.

As illustrated in FIG. 5, at block 51, an original material layer 11 is formed on a substrate 10.

The original material layer 11 includes insulating particles and conductive particles distributed in the insulating particles.

As illustrated in FIG. 7, at block S2, the original material layer 11 is locally treated. The conductive particles in the treated region are substantially electrically connected to each other such that the treated region forms a conductive region 121. The conductive particles in the untreated region are separated by the insulating particles such that the untreated region forms an insulation region 123. The operations at block S2 includes operations at the following blocks.

Specifically, at block S21, the original material layer 11 is patterned by irradiating to form a number of first regions 113 and a number of second regions 114 separated by the first regions 113, as illustrated in FIG. 6. When there is no irradiation of special external light, the insulating properties of the original material layer 11 are stable. When there is an irradiation of a special light (such as a femtosecond laser with a wavelength of 780 nm to 820 nm), the chemical properties of the insulating particles of the original material layer 11 are changed and produces an acidic substance or acidic particles. In the locally treatment, T-type phenylalanine molecular groups, that is, T-Boc molecular groups, of the insulating particles in the original material layer 11 falls off. Specifically, the T-Boc molecular groups of the insulating particles in the original material layer 11 fall off and the insulating particles are decomposed into trifluoromethanesulfonic acid composite gel particles with the particle size of 80 nm to 150 nm. The insulating photosensitive particles are composite organogel particles of calixarene and the derivative of trifluoromethanesulfonic acid or triphenylsulfonate protected by T-type phenylalanine molecular groups. In this embodiment, the second regions 114 are not irradiated and maintain its original state. The first regions 113 are exposed to be irradiated and the chemical proper-ties thereof are changed.

The original material layer 11 is a photosensitive material layer and includes an insulating photosensitive layer. An irradiated region of the insulating photosensitive layer forms the conductive region and an unirradiated region of the insulating photosensitive layer forms the insulating region in the locally treating process. The insulating particles in the conductive region 121 are substantially located at sides of the conductive particles. The insulating particles in the insulating region 123 are substantially located among the conductive particles, in other words, the insulating particles in the insulating region 123 are distributed in the conductive particles. The insulating particles 1231 and the conductive particles 1232 in the insulating region 123 are alternately stacked layer by layer. The insulating particles 1231 in the insulating region 123 are gathered at a position adjacent to a surface of the substrate 10. The particle sizes of the insulating particles in the conductive region 121 are substantially smaller than the particle sizes of the insulating particle 1231 in the insulating region 123.

As illustrated in FIG. 7, at block S22, the patterned original material layer 11 is placed into a weak alkaline solution. The insulating particles in the first regions 113 are changed into small insulating acidic molecule particles 115, to form an insulating particle layer 1211, as illustrated in FIG. 3. Specifically, under the action of the weak alkaline solution, the trifluoromethanesulfonic acid composite gel particles are neutralized into small insulating acidic molecule particles 115. Due to gravity and diffusion, the small insulating acidic molecule particles 115 move downward and leave the conductive particles. Without the separations of the small insulating acidic molecule particles 115, the conductive particles move to contact along a direction perpendicular to the substrate 10 to form a first conductive particle layer 1212 such that the irradiated first regions 113 are conductive to form the conductive regions 121. The particle size of the small insulating acidic molecule particles 115 ranges from 1 nm to 50 nm. Being unirradiated by light, the insulating particles in the second regions 114 are not affected by the weak alkaline solution and the second region 114 remains original to form insulating regions 123. The conductive regions 121 and the insulating regions 123 form a conductive layer 12.

At block 23, a cover plate 14 is fixed to the conductive layer 12 through an adhesive layer 100 to finally form a touch sensor illustrated in FIG. 1.

The locally treating process at block S2 includes locally irradiating the original material layer 11 and neutralizing the irradiated original material layer 11.

Referring to FIG. 2, the insulating regions 123 formed by the second regions 114 include insulating photosensitive particles 1231 and conductive particles 1232 separated by the insulating photosensitive particles 1231. That is, operated by the above operations, the composition of the original material layer 11 is changed and the conductive layer 12 including the insulating regions 123 and the conductive regions 121 is formed.

In this embodiment, irradiating the original material layer 11 is mainly for patterning and a patterned light shielding plate 16 is applied thereto, as illustrated in FIG. 6. The light shielding plate 16 includes a number of light shielding regions 161 and a number of light transmission regions 162. The light shielding plate 16 is placed above the original material layer 11, with the light transmission regions 162 located above the first regions 113 and the light shielding regions 161 located above the second regions 114. The first regions 113 form the conductive regions 121 when the light passes through the light transmitting regions 162 to irradiate the first regions 113.

The conductive layer 12 of the touch sensor described in the present disclosure is patterned by doping insulating photosensitive particles and conductive particles. The conductive particles in the irradiated region are substantially electrically connected to form a conductive structure and the unirradiated region remains insulated. Therefore, a patterned electrode is formed. The irradiated region is not removed and remains in place. Furthermore, since the irradiated region is soaked in alkaline solution and irradiated, the optical properties thereof are insignificantly changed. The difference in reflectance between the irradiated region and the unirradiated region is less than 1%. Thus, the unirradiated region may not be perceived by the human eye.

The manner of patterning the electrode described above is achieved by irradiating the photosensitive material. It is to be understood that the manner of patterning the electrode may also be achieved by heating the heat sensitive material. For example, the heat sensitive material may have insulating particles and conductive particles. By locally heat-treating the heat sensitive material, the insulating particles are decomposed into small molecules to cause the conductive particles to contact with each other to form a conductive structure. The unheated region remains in its original insulation state. Therefore, patterning the electrode may also be achieved.

Furthermore, the structure and method for patterning an electrode are also applicable to other touch sensors, such as a resistance sensor, a surface acoustic wave sensor, and the like.

The above are only the preferred embodiments of the present disclosure. It is noted that those skilled in the art can also make several improvements and modifications without departing from the principles of the present disclosure. These improvements and modifications are intended to be included in the scope of the present disclosure.

What is claimed is:

1. A touch sensor, comprising:
a substrate;
a conductive layer laminated on a surface of the substrate, the conductive layer comprising a conductive region and an insulating region, the conductive region and the insulating region formed by locally treating an original material layer having conductive particles, the treated region of the original material layer forming the conductive region, and the untreated region of the original material layer forming the insulating region;
wherein the conductive region comprises the conductive particles substantially electronically connected to each other, and the insulating region comprises the conductive particles substantially separated from each other.

2. The touch sensor of claim 1, wherein the original material layer, the insulating region, and the conductive region each comprise insulating particles, the insulating particles in the insulating region are substantially located among the conductive particles, and the insulating particles in the conductive region are substantially located at sides of the conductive particles.

3. The touch sensor of claim 2, wherein the insulating region comprises a plurality of layers of insulating particles and a plurality of layers of conductive particles, and two adjacent layers of conductive particles in the insulating region are separated by a layer of insulating particles.

4. The touch sensor of claim 2, wherein the conductive region comprises a plurality of layers of conductive particles, two adjacent layers of conductive particles in the conductive region contact each other, and the insulating particles in the conductive region are adjacent to the substrate.

5. The touch sensor of claim 2, wherein the particle sizes of the insulating particles in the conductive region are substantially smaller than the particle sizes of the insulating particles in the insulating region.

6. The touch sensor of claim 2, wherein the insulating particles of the original material layer are decomposed to form the insulating particles of the conductive region.

7. The touch sensor of claim 1, wherein the original material layer comprises an insulating photosensitive layer, an irradiated region of the insulating photosensitive layer forms the conductive region and an unirradiated region of the insulating photosensitive layer forms the insulating region in the locally treating process.

8. The touch sensor of claim 2, wherein the insulating particles of the original material layer comprise composite organogel particle of calixarene and a derivative of trifluoromethanesulfonic acid or triphenylsulfonate, protected by a T-phenylalanine molecular group.

9. The touch sensor of claim 8, wherein the mass ratio of the calixarene to the derivative of trifluoromethanesulfonic acid or triphenylsulfonate is 1:9.5˜1:10.

10. The touch sensor of claim 8, wherein the T-type phenylalanine molecular group of the insulating particles in the original material layer falls off in the locally treating process.

11. The touch sensor of claim 1, further comprising a cover plate covering the conductive layer, wherein the cover plate is connected to the conductive region and the insulating region of the conductive layer by an adhesive layer.

12. The touch sensor of claim 1, wherein the difference in reflectance between the insulating region and the conductive region is less than 1%.

13. A method for manufacturing a touch sensor, comprising:
forming an original material layer on a substrate, the original material comprising insulating particles and conductive particles distributed in the insulating particles; and
locally treating the original material layer, the treated region of the original material layer forming a conductive region where the conductive particles are substantially electrically connected to each other, and the untreated region of the original material layer forming an insulating region where the conductive particles are substantially separated by the insulating particles.

14. The method of claim 13, wherein the insulating particles in the conductive region are substantially located at sides of the conductive particles, and the insulating particles in the insulating region are substantially located among the conductive particles.

15. The method of claim 13, wherein the insulating particles and the conductive particles in the insulating region are alternately stacked layer by layer, and the insulating particles in the conductive region are gathered adjacent to a surface of the substrate.

16. The method of claim 13, wherein the particle sizes of the insulating particles in the conductive region are substantially smaller than the particle sizes of the insulating particles in the insulating region.

17. The method of claim 13, wherein the original material layer is a photosensitive material layer.

18. The method of claim 17, wherein locally treating the original material layer, comprises:
locally irradiating the original material layer; and
neutralizing the irradiated original material layer.

19. The method of claim 18, wherein the insulating particles in the original material layer comprise acidic particles protected by molecular groups, and the molecular groups fall off to expose the acidic particles when locally irradiating the original material layer.

20. The method of claim 19, wherein the acidic particles are neutralized with a weak alkaline solution to form the insulating particles of the conductive region after locally irradiating the original material layer.
